(19) United States
(12) Patent Application Publication
(10) Pub. No.: US 2006/0018543 A1
(43) Pub. Date: Jan. 26, 2006

(54) Image decoder and image decoding method

(75) Inventor: Kenya Michiishita, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/144,591

(22) Filed: Jun. 6, 2005

(30) Foreign Application Priority Data
Jun. 8, 2004 (JP) 2004-170112

(51) Int. Cl. G06K 9/00; G06K 9/36

(52) U.S. Cl. 382/181; 382/232

(57) ABSTRACT

An image decoder, which separates luminance data and color difference data from image data in a format in which, while based on ITU-R656, the luminance data (Y), color difference data (Cb/Cr), synchronization data (XY), and identification codes (FF and 00) are at twice the rate of the transmission clock, includes a first element for capturing image data with the timing of the rising edge of the transmission clock, a second element for capturing image data with the timing of the falling edge of the transmission clock, and a detector for rendering uniform the timing of the data output from the first element and second element, for judging from the signals with timing rendered uniform whether identification codes exist, and for detecting the synchronization data with the timing of the presence of the identification codes. Accordingly, luminance data and color difference data can be separated, and synchronization data can be detected.

### CROSS-REFERENCES TO RELATED APPLICATIONS

The present invention contains subject matter related to Japanese Patent Application JP 2004-170112, filed in the Japanese Patent Office on Jun. 8, 2004, the entire contents of which being incorporated herein by reference.

### BACKGROUND OF THE INVENTION

1. Field of the Invention

This invention relates to a decoder and decoding method for separating luminance data and color difference data from image data in a format stipulated by the ITU-R656 standard and the like.

2. Description of the Related Art

ITU-R601 is widely adopted as a standard specification for digital component signals in television broadcasts and the like; there also exists ITU-R656, which expands ITU-R601 for 10-bit or 8-bit parallel transmission. At present, ITU-R656 is applied only to the SD (Standard Definition) signals 480i and 576i.

FIG. 1 compares this ITU-R656 format with ITU-R601. In ITU-R601, as is well known, the sampling frequency for luminance data Y is 13.5 MHz, while the sampling frequency for color difference data Cr (=R−Y) and for color difference data Cb (=B−Y) is 6.25 MHz. The numbers of samples for luminance data Y and color difference data Cb/Cr in one horizontal line are respectively 858 and 429 for 480i, and are respectively 864 and 432 for 576i. The numbers of effective pixels for luminance data Y and color difference data Cb/Cr per horizontal line are 720 and 360 respectively.

In ITU-R656, the luminance data Y and color difference data Cb/Cr in ITU-R601 are time-division multiplexed in the order Cb-Y-Cr-Y- . . . at 27 MHz, which is twice the rate of the luminance data Y. In addition, four-word SAV (Start of Active Video) and EAV (End of Active Video) codes, indicating the beginning and end of the image interval (effective pixel range), are added to each horizontal line. At the bottom of FIG. 1, the horizontal blanking interval from EAV to SAV is described in analog form together with the horizontal synchronization signal Hsync generated during this horizontal blanking interval.

FIG. 2 shows the SAV and EAV data structures. In SAV and EAV, three identification codes, FF (all-ones), 00 (all zeroes), 00, are positioned before the synchronization data XY in order to facilitate identification of the synchronization data XY.

The uppermost bit (bit 9) of the synchronization data XY is fixed at “1”. Bit 8 is the field ID for interlacing, and is “0” for odd-numbered fields and “1” for even-numbered fields. Bit 7 is vertical blanking information, and is “1” in the vertical blanking interval and is “0” otherwise.

Bit 6 is H information to discriminate between SAV and EAV, and is “0” for SAV and “1” for EAV. Bits 5 through 2 are parity bits for error correction. Bits 1 and 0 are not defined (and do not exist in the 8-bit format).

FIG. 3 illustrates a method of decoding data in the ITU-R656 format into the ITU-R601 format (that is, separating the luminance data Y and the color difference data Cb/Cr). If data is alternately distributed with the timing of the rising edge of the 27 MHz clock signal which is transmitted together with the ITU-R656 format data, then the luminance data Y and color difference data Cb/Cr can be separated. Since color difference data Cb immediately follows the synchronization data XY in the SAV codes, by detecting the synchronization data XY based on the identification codes FF, 00, 00, it is possible to discriminate luminance data Y from color difference data Cb/Cr.

The H information in the synchronization data XY is used to start a pixel counter with, for example, the timing of a change from “1” to “0”, to generate a horizontal synchronization signal with predetermined timing. The vertical blanking information and field ID in the synchronization data XY is used to generate a vertical synchronization signal with predetermined timing (for odd-numbered fields, the timing of the horizontal synchronization signal, and for even-numbered fields, the timing at which one-half the horizontal interval has elapsed from the horizontal synchronization signal) through the line counter.

In image apparatuses of the past (for example, a digital television broadcast receiver) to which data is input in ITU-R656 format applied to 480i and 576i, data input in the ITU-R656 format is decoded to the ITU-R601 format using the method indicated in FIG. 3, after which various operations of image signal processing are performed on the luminance data Y and color difference data Cb/Cr (refer to Patent reference 1, for example).

[Patent Reference 1] Published Japanese Patent Application No. 2002-112280, paragraphs 0017 to 0028, FIGS. 1 to 6, for example).

### SUMMARY OF THE INVENTION

It is desirable that the ITU-R656 format also be applicable in the future to the 1080i (50/60 Hz), 720p (50/60 Hz), 480p, and 576p HD (High Definition) signals and to progressive signals.

However, application of the ITU-R656 format without modification to HD signals and progressive signals is difficult, for the following reasons (1) to (3).

(1) For example, in the case of 1080i the sampling frequency for luminance data Y is 74.25 MHz, so that luminance data and color difference data are time-division multiplexed at twice the rate, that is, approximately 150 MHz. Hence the frequency of the transmission clock between an encoder which encodes data in the ITU-R601 format into the ITU-R656 format and a decoder which decodes data from the encoder in the ITU-R656 format into the ITU-R601 format must be approximately 150 MHz. The toggle frequency for switching of the transmission clock between “0” and “1” is then approximately 300 MHz, which makes the interface (timing coincidence and the like) between the encoder and decoder extremely difficult to be obtained.

(2) At the time of design of the decoder, as the operating margin, it is necessary to ensure operation at a rate approximately 1.5 times to two times the input clock frequency; hence when a 150 MHz transmission clock is input, an operating rate of roughly 300 MHz must be ensured.

(3) In the clock path within the decoder, a buffer with high driving capacity is employed to prevent clock skew. When a 150 MHz transmission clock is input to this buffer, the current consumption in the buffer becomes substantial, which affects the decoder voltage resistance and the like.

Thus, the reason for the difficulty in applying ITU-R656 without modification to HD signals and progressive signals is the high frequency of the transmission clock. On the other hand, formats such as those shown in FIGS. 4A and 4B are conceivable as formats which, while based on ITU-R656, lower the transmission clock frequency.

In these formats, the transmission clock is set to the same frequency (for example, 74.25 MHz for 1080i) as twice the period of ITU-R656, that is, as the luminance signal sampling frequency for ITU-R601; and the order of time division multiplexing of the luminance data Y and color difference data Cb/Cr, as well as the positions and data structures of SAV and EAV, are the same as those in the ITU-R656 format shown in FIG. 1.

In the format of FIG. 4A, the rates of the luminance data Y and color difference data Cb/Cr are twice the clock frequency, but the SAV and EAV rates are the same as the clock frequency. For this reason, the format of FIG. 4A is hereinafter called the “DDR-SDR format”. (Here DDR is an abbreviation of “Double Data Rate”, and SDR is an abbreviation of “Standard Data Rate”.)

In the format of FIG. 4B, the rates of the luminance data Y and color difference data Cb/Cr, as well as the SAV and EAV rates, are twice the clock frequency. For this reason, the format of FIG. 4B is hereinafter called the “DDR-DDR format”.

Using the DDR-SDR format and DDR-DDR format, the transmission clock frequency can be held low, so that application to HD signals and progressive signals is possible.

However, if data in these formats is distributed with the timing of the rising edge of the clock signal, as shown in FIG. 3, then decoding into the ITU-R601 format is not possible. Consequently, decoders of the past may not decode data in these DDR-SDR and DDR-DDR formats into the ITU-R601 format.

This invention was devised in light of the above problems, and provides an image decoder and image decoding method to decode data in the DDR-SDR format and DDR-DDR format into the ITU-R601 format.

An image decoder according to an embodiment of this invention which separates luminance data and color difference data from image data in, for example, the DDR-DDR format shown in FIG. 4B or the like in which luminance data and color difference data are time-division multiplexed, with synchronization data indicating the beginning and end of the image interval as well as identification codes for identification of synchronization data added, and with the luminance data, color difference data, synchronization data and identification codes encoded at several times the rate of the transmission clock, includes first capture means for capturing image data with timing at the rising edge of the transmission clock signal; second capture means for capturing image data with timing at the falling edge of the transmission clock signal; and detection means for rendering uniform the timing of the output data of the first capture means and of the output data of the second capture means, for judging the presence of identification codes from the signals with timing rendered uniform, and for detecting the synchronization data with the timing of the presence of identification codes.

In this image decoder, when image data is input together with a transmission clock, image data is captured with the timing of the rising edge of the transmission clock by the first capture means, and image data is captured with the timing of the falling edge of the transmission clock by the second capture means.

In this image data, luminance data and color difference data are time-division multiplexed at several times the rate of the transmission clock, so that by capturing respectively data on the rising edge and on the falling edge of the transmission clock, luminance data and color difference data are separated.

With respect to the image data, because the synchronization data and identification codes are also added at several times the rate of the transmission clock, synchronization data and identification codes are separated by the first capture means and second capture means, so that without further measures being taken, the synchronization data may not be detected based on the identification codes.

However, because the detection means renders uniform the timing of the output data of the first capture means and the output data of the second capture means, the presence of identification codes is judged from signals with timing thus rendered uniform, and synchronization data is detected with the timing of the presence of the identification codes. By this means, luminance data and color difference data can be separated, and synchronization data can be detected.

Further, in the case of decoding image data in a format in which three identification codes (identification codes FF, 00, 00) are added for one synchronization data item (synchronization data XY), in, for example, the DDR-DDR format shown in FIG. 4B, the detection means renders uniform the timing of the current output data of the first capture means, the output data of one clock cycle previous of the first capture means, the current output data of the second capture means, and the output data of one clock cycle previous of the second capture means; with timing of three data items being identification codes of these four data items rendered uniform, and the remaining one data item is detected as the synchronization data.

Further, in this image decoder, as an example, it is preferable that second detection means be further included which judges the presence of identification codes from the output data of only one among the first capture means and the second capture means to detect synchronization data; and that, when second image data is input with luminance data and color difference data time-division multiplexed and with synchronization data indicating the beginning and end of the image interval and identification codes to identify the synchronization data added, for example, in the DDR-SDR format shown in FIG. 4A, and with the luminance data and color difference data at twice the rate of the transmission clock and the synchronization data and identification codes at the same rate as the transmission clock, the synchronization data be detected by the second detection means.

In this second image data, the synchronization data and identification codes are added at the same rate as the transmission clock, so that the synchronization data and identification codes are captured without being separated by both the first capture means and by the second capture means. Hence when such second image data is input, the synchronization data can be detected by the second detection means based on identification codes.

Accordingly, in the case in which for example either data in the DDR-SDR format shown in FIG. 4A or data in the DDR-DDR format shown in FIG. 4B is input, the luminance data and color difference data are separated, and the synchronization data can be detected.

An image decoding method according to an embodiment of this invention, which separates luminance data and color difference data from image data in, for example, the DDR-DDR format shown in FIG. 4B or the like in which luminance data and color difference data are time-division multiplexed, with synchronization data indicating the beginning and end of the image interval as well as identification codes for identification of synchronization data added, and with the luminance data, color difference data, synchronization data and identification codes encoded at several times the rate of the transmission clock, includes a first capture step of capturing image data with the timing of the rising edge of a transmission clock signal input together with the image data; a second capture step of capturing image data with the timing of the falling edge of the transmission clock signal; and a detection step of rendering uniform the timing of signals captured in the first capture step and signals captured in the second capture step, of judging the presence of identification codes from the signals, the timing of which has been rendered uniform, and of detecting the synchronization data with the timing of the presence of identification codes.

In this image decoding method, when image data is input together with a transmission clock signal, image data is captured in the first capture step with timing on the rising edge of the transmission clock signal, and image data is captured in the second capture step with timing on the falling edge of the transmission clock signal.

In the image data, luminance data and color difference data are time-division multiplexed at several times the rate of the transmission clock, so that by performing capture with timing on the rising and falling edges of the transmission clock signal, the luminance data and color difference data are separated.

Further, because in the image data the synchronization data and identification codes are also added at several times the rate of the transmission clock, the synchronization data and identification codes are separated in the first capture step and second capture step, so that without further measures being taken, the synchronization data may not be detected based on the identification codes. However, in the detection step the timing of the signal captured in the first capture step and the signal captured in the second capture step is rendered uniform, the presence of identification codes is judged from the signals with timing rendered uniform, and synchronization data is detected with the timing of the presence of the identification codes.

By this means, luminance data and color difference data are separated, and synchronization data can be detected.

According to the embodiments of this invention, luminance data and color difference data can be separated from image data in a format in which, while based on ITU-R656, the luminance data, color difference data, synchronization data, and identification codes are at twice the rate of the transmission clock, and the synchronization data can be detected.

Further, luminance data and color difference data can be separated, and synchronization data can be detected, upon the input of either image data in a format in which, while based on ITU-R656, the luminance data, color difference data, synchronization data, and identification codes are at twice the rate of the transmission clock, or image data in a format in which, while based on ITU-R656, the luminance data and color difference data are at twice the rate of the transmission clock, while the synchronization data and identification codes are at the same rate as the transmission clock.

### BRIEF DESCRIPTION OF THE DRAWINGS

FIG. 1 shows the ITU-R656 format;

FIG. 2 shows the SAV and EAV data structure in the ITU-R656 format;

FIG. 3 shows a method of decoding data in the ITU-R656 format; and,

FIGS. 4A and 4B show the DDR-DDR format and DDR-SDR format;

FIG. 5 is a block diagram showing an example of a configuration of a decoder according to an embodiment of the present invention;

FIG. 6 is a block diagram showing the configuration of the YC separation circuit of FIG. 5;

FIG. 7 is a block diagram showing the configuration of the DDR-DDR SAV/EAV detection circuit 7 of FIG. 5;

FIG. 8 shows the operation of the decoder of FIG. 5 when DDR-DDR format data is input;

FIG. 9 shows the operation of the decoder of FIG. 5 when DDR-DDR format data is input;

FIG. 10 shows the operation of the decoder of FIG. 5 when DDR-SDR format data is input; and

FIG. 11 shows the operation of the decoder of FIG. 5 when ITU-R656 format data is input.

### DESCRIPTION OF THE PREFERRED EMBODIMENTS

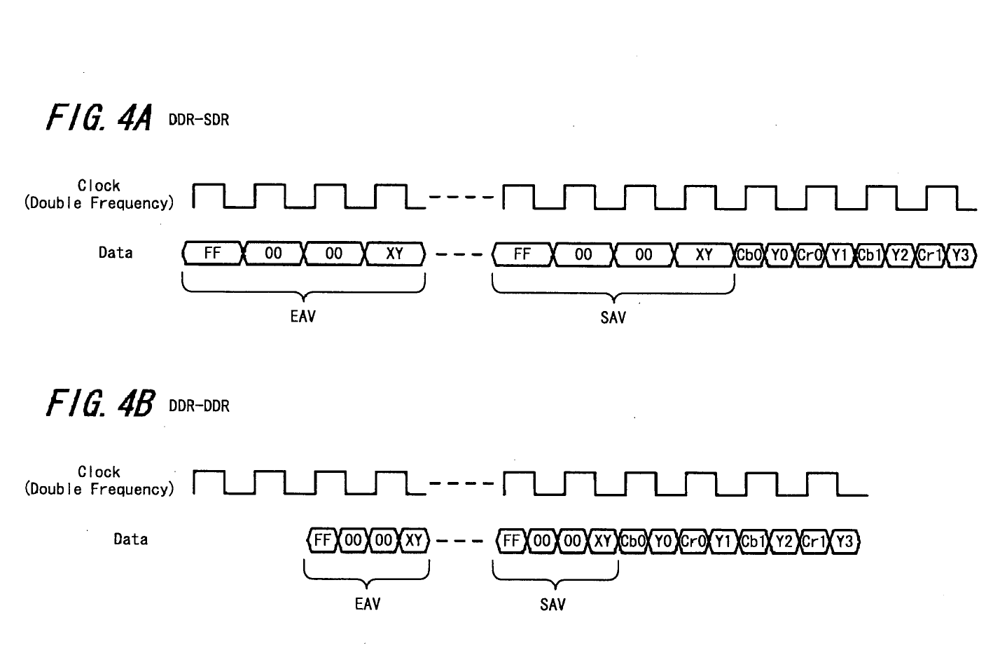

Hereinafter, embodiments in which this invention is applied to decode data in the DDR-DDR format and DDR-SDR format shown in FIGS. 4A and 4B into the ITU-R601 format are explained in detail, referring to the drawings.

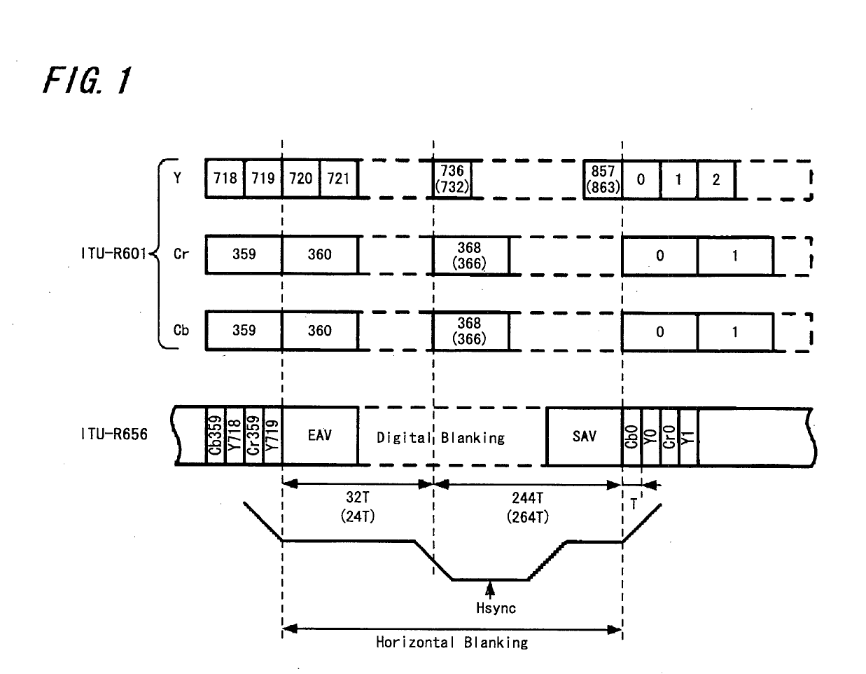

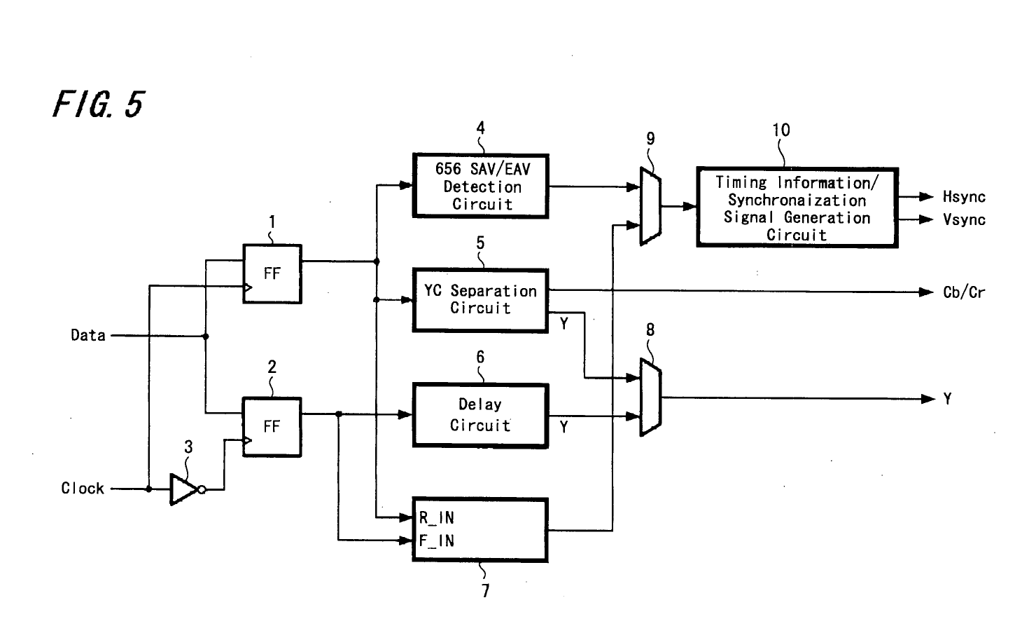

FIG. 5 is a block diagram showing an example of a configuration of a decoder to which this invention is applied. This decoder is used to decode data in the DDR-DDR format, data in the DDR-SDR format, and data in the ITU-R656 format (FIG. 1).

Image data supplied to the decoder from outside together with a transmission clock signal is input to two flip-flops 1 and 2. The transmission clock is input to a flip-flop-1 and, after being inverted by an inverter 3, is input to a flip-flop 2.

The flip-flops 1 and 2 each latch the input data with the timing of the rising edge of the input clock signal. Hence the flip-flop 1 latches the input data with the timing of the rising edge of the transmission clock, and the flip-flop 2 latches the input data with the timing of the falling edge of the transmission clock.

The data output from the flip-flop 1 is sent to a 656 SAV/EAV detection circuit 4 and YC separation circuit 5, and is also sent to an input terminal R_IN of a DDR-DDR SAV/EAV detection circuit 7.

The data output from the flip-flop 2 is sent as luminance data Y to a delay circuit 6, and is also sent to an input terminal F_IN of the DDR-DDR SAV/EAV detection circuit 7.

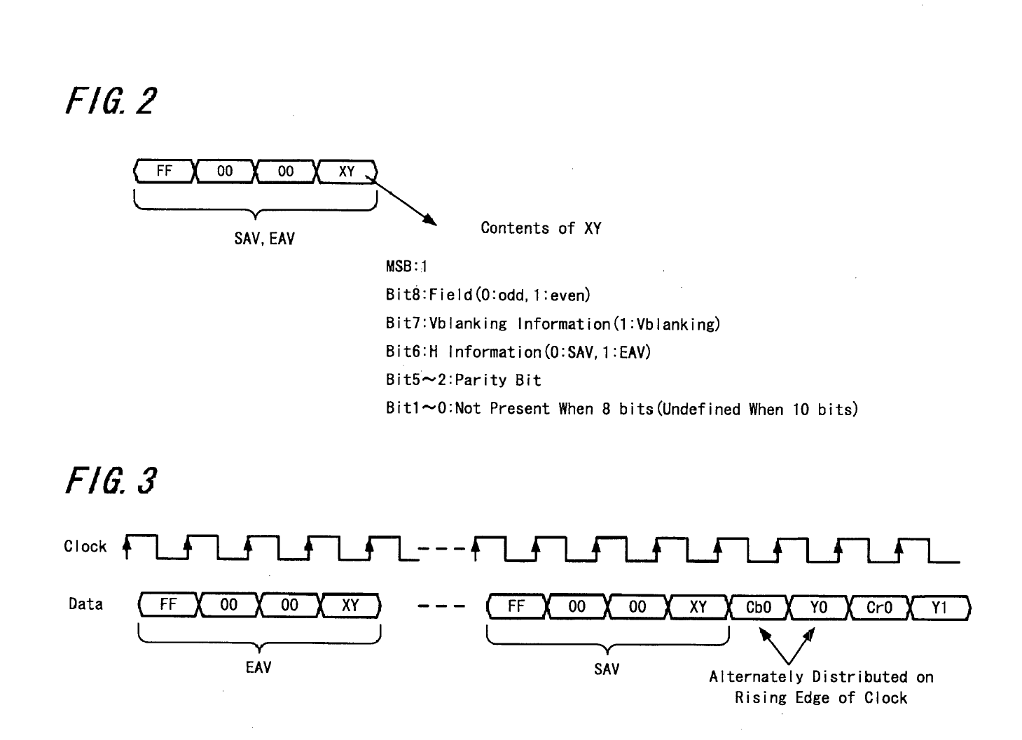

The 656 SAV/EAV detection circuit 4 is a circuit which detects SAV and EAV codes (FIG. 2) from data in the ITU-R656 format. The configuration of this 656 SAV/EAV detection circuit 4 may be the same as that of the SAV/EAV detection circuit within an existing decoder which decodes data in the ITU-R656 format, and so a detailed explanation is omitted. The SAV and EAV codes detected by the 656 SAV/EAV detection circuit 4 are input to one of the input terminals of a two-input, one-output selector 9.

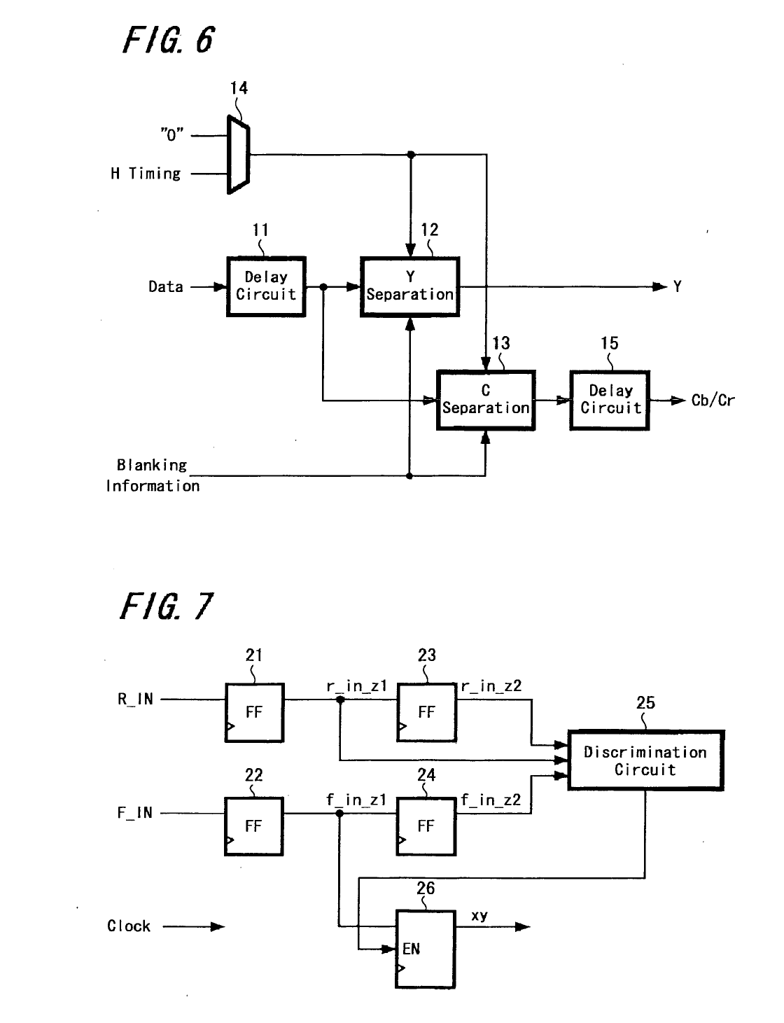

The YC separation circuit 5 is a circuit which separates luminance data Y and color difference data from data in the ITU-R656 format. FIG. 6 is a block diagram showing a configuration of the YC separation circuit. Data output from the flip-flop 1 (FIG. 5) passes through a delay circuit 11 (a circuit used to adjust the delays of the 656 SAV/EAV detection circuit 4, the DDR-DDR SAV/EAV detection circuit 7, and a timing information/synchronization signal generation circuit 10 in FIG. 5), and is input to a Y separation portion 12 and C separation portion 13.

As is described later on, H timing information, as “1”s and “0”s with the timing of the luminance data Y and color difference data Cb/Cr respectively in ITU-R656 format, is sent from the timing information/synchronization signal generation circuit 10 of FIG. 5 to the YC separation circuit 5. This H timing information is input to one of the input terminals of the two-input, one-output selector 14, with the fixed value “0” input to the other input terminal of the selector 14. The selector 14 is controlled by a higher-level controller, not shown (for example, when the decoder of FIG. 5 is provided within a television receiver, by a controller which controls the various portions of the television receiver). The output of selector 14 is supplied, as control signals, to the Y separation portion 12 and C separation portion 13.

As described later on, blanking information to identify the blanking interval (the interval from EAV to SAV) and the image interval is also sent from the timing information/synchronization signal generation circuit 10 to the YC separation circuit 5, and is supplied to the Y separation portion 12 and to the C separation portion 13.

The Y separation portion 12 outputs the input data without modification only when the control signal is “1” and the blanking information indicates the image interval, and at other times the Y separation portion 12 does not output data. The data output from the Y separation portion 12 is output from the YC separation circuit 5 as luminance data Y, and as shown in FIG. 5, is input to one of input terminals of a two-input, one-output selector 8.

The C separation portion 13 outputs the input data without modification only when the control signal is “0” and the blanking information indicates the image interval, and at other times does not output data. The data output from the C separation portion 13 is output from the YC separation circuit 5 after the timing with the output data from the Y separation portion 12 is adjusted in the delay circuit 15, and is output from the decoder as color difference data Cb/Cr.

The delay circuit 6 of FIG. 5 is used to output luminance data Y from the flip-flop 2 with the timing adjusted to that of the color difference data Cb/Cr from the YC separation circuit 5, and includes a latch circuit with an enable terminal, or the like. The blanking timing information is also applied to this latch circuit from the timing information/synchronization signal generation circuit 10, and input data is latched only when the blanking information indicates an image interval. Luminance data Y output from the delay circuit 6 is input to the other input terminal of the selector 8. The selector 8 is controlled by the higher-level controller described above, and the output of the selector 8 is output from the decoder as luminance data Y.

The DDR-DDR SAV/EAV detection circuit 7 is a circuit which detects SAV and EAV codes from data in the DDR-DDR format (FIG. 4B). FIG. 7 is a block diagram showing a configuration of the DDR-DDR SAV/EAV detection circuit 7. Data input to the input terminal R_IN is latched by a flip-flop 21 with the timing of the rising edge of the transmission clock. Data input to the input terminal F_IN is latched by a flip-flop 22 with the timing of the rising edge of the transmission clock.

The data r_in_z1 output from the flip-flop 21 is latched by a flip-flop 23 with the timing of the rising edge of the transmission clock, and is sent to a discrimination circuit 25. Data f_in_z1 output from the flip-flop 22 is latched by a flip-flop 24 with the timing of the rising edge of the transmission clock, and is input to a latch circuit 26.

The data r_in_z2 output from the flip-flop 23 and the data f_in_z2 output from the flip-flop 24 are sent to the discrimination circuit 25. The discrimination circuit 25 discriminates whether the conditions data r_in_z1=0 (all-“0”s code), r_in_z2=FF (all-“1”s code), and whether data f_in z2=00 are satisfied, and only if the conditions are satisfied, applies an enable signal to the latch circuit 26. Data output from the latch circuit 26 is output as SAV or EAV codes from the DDR-DDR SAV/EAV detection circuit 7, and are input to the other input terminal of the selector 9 in FIG. 5. The selector 9 is controlled by the higher-level controller described above, and output from the selector 9 is supplied to the timing information/synchronization signal generation circuit 10.

From the supplied SAV and EAV codes, the timing information/synchronization signal generation circuit 10 uses the fact that color difference data Cb immediately follows the synchronization data XY in SAV codes (FIG. 3) to generate H timing information, which is “1”s and “0”s with the timing of luminance data Y and color difference data Cb/Cr at one-half the frequency of the transmission clock. As explained above, this H timing information is sent to the YC separation circuit 5 (in FIG. 5, the signal line used to send this H timing information is not shown).

Further, from the supplied SAV and EAV codes, the timing information/synchronization signal generation circuit 10 generates blanking information to identify the blanking interval (interval from EAV to SAV) and the image interval. As explained above, this blanking information is sent to the YC separation circuit 5 and delay circuit 6 (in FIG. 5, the signal line used to send this blanking information is not shown).

The timing information/synchronization signal generation circuit 10 starts a pixel counter with the timing of the change from “1” to “0” of the H information in the SAV and EAV synchronization data XY (FIG. 2), and generates a horizontal synchronization signal Hsync with predetermined timing.

Further, the timing information/synchronization signal generation circuit 10 uses the vertical blanking information and field ID in the synchronization data XY (FIG. 2) to generate, by means of a line counter, a vertical synchronization signal Vsync with predetermined timing (for an odd-numbered field, with the timing of the horizontal synchronization signal, and for an even-numbered field, with the timing at which one-half of a horizontal interval has elapsed since a horizontal synchronization signal).

The horizontal synchronization signal Hsync and vertical synchronization signal Vsync generated by the timing information/synchronization signal generation circuit 10 are output from the decoder together with luminance data Y and color difference data Cb/Cr.

The configuration of this timing information/synchronization signal generation circuit 10 may be the same as that of the circuit which generates the timing information and synchronization signals in an existing decoder to decode data in the ITU-R656 format, and so a detailed explanation is omitted.

Next, the manner of decoding within this decoder of data in the DDR-DDR format, of data in the DDR-SDR format, and of data in the ITU-R656 format is explained.

[Decoding of Data in the DDR-DDR Format]

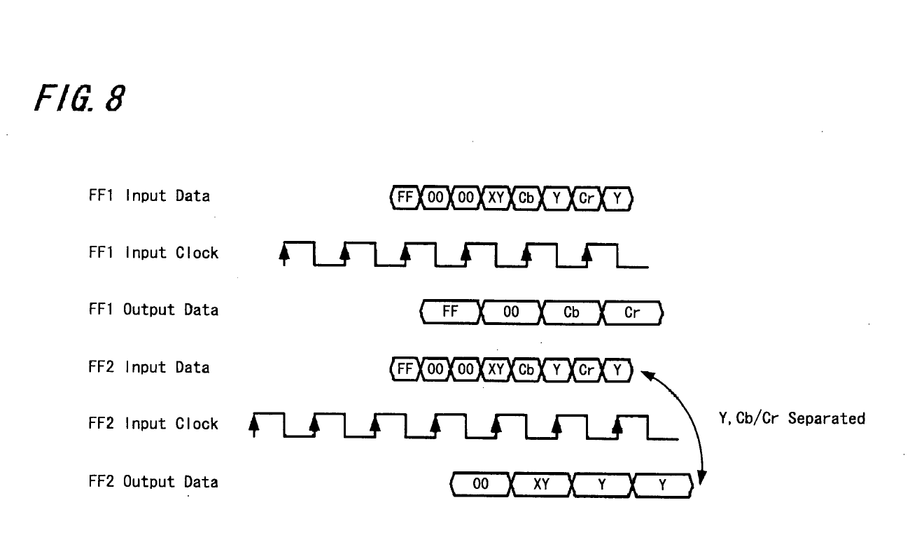

First, the manner of decoding of data in the DDR-DDR format shown in FIG. 4B is explained. Data in the DDR-DDR format is input to the decoder together with a transmission clock (for example, in the case of 1080i, a 74.25 MHz clock), and as shown in FIG. 8, data is captured with the timing of the rising edge of the transmission clock by the flip-flop 1, and data is captured with the timing of the falling edge of the transmission clock by the inverter 3 and flip-flop 2.

In data in the DDR-DDR format, luminance data Y and color difference data Cb/Cr are time-division multiplexed at twice the rate of the transmission clock, so that by capturing data with the timing of the rising edge of the transmission clock the color difference data Cb/Cr is separated, and by capturing data with the timing of the falling edge of the transmission clock the luminance data Y is separated.

In data in the DDR-DDR format, the synchronization data XY and identification codes 00, FF, 00 are also added at twice the rate of the transmission clock, so that as shown in FIG. 8, the synchronization data XY and identification codes 00, FF, 00 are separated by the flip-flop 1 and flip-flop 2; hence without further measures, the synchronization data XY may not be detected based on the identification codes 00, FF, 00.

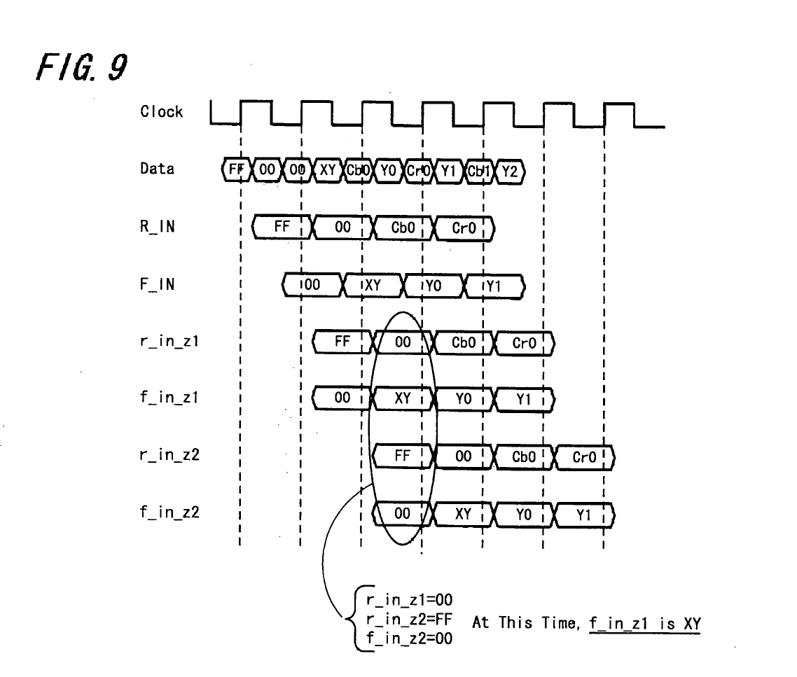

However, as shown in FIG. 9, by means of the DDR-DDR SAV/EAV detection circuit 7 the timings of the current output data of the flip-flop 1, the output data one clock cycle previous of the flip-flop 1, the current output data of the flip-flop 2, and the output data one cycle previous of the flip-flop 2 are rendered uniform; and of these four data sets with timing rendered uniform, the timing with which the three data sets (data r_in_z1, r_in_z2, f_in_z2) are 00, FF, 00 is used to detect the remaining data set (f_in_z1) as the synchronization data XY. Accordingly, the luminance data Y and color difference data Cb/Cr are separated, and the synchronization data XY can be detected.

When data in the DDR-DDR format is input to this decoder, under the control of the higher-level controller, the fixed value “0” is selected by the selector 14 in the YC separation circuit 5, the output of the delay circuit 6 is selected by the selector 8, and the output of the DDR-DDR SAV/EAV detection circuit 7 is selected by the selector 9.

Hence, in this case the color difference data Cb/Cr separated by the flip-flop 1 except for the blanking interval passes through the YC separation circuit 5 and is output from the decoder, and the luminance data Y separated by the flip-flop 2 except for the blanking interval passes through the delay circuit 6 and selector 8 and is output from the decoder.

[Decoding of Data in the DDR-SDR Format]

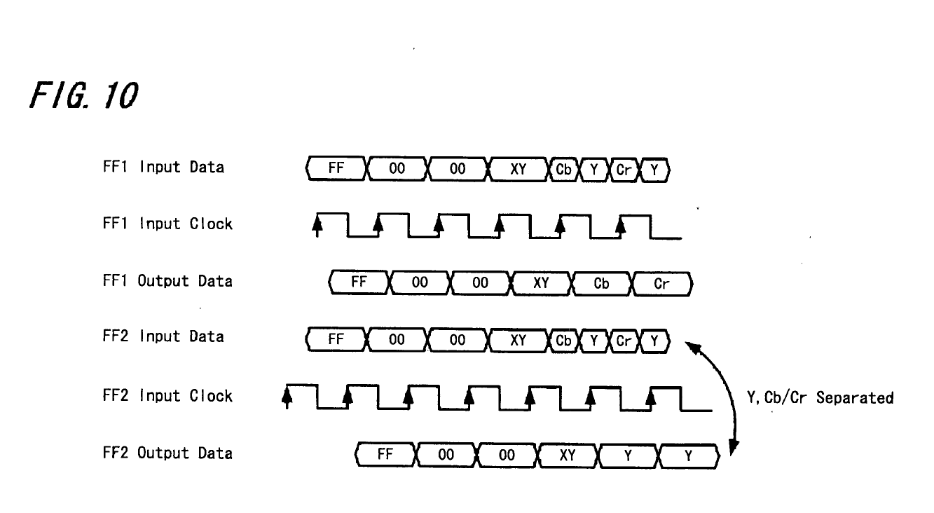

Next, the manner of decoding data in the DDR-SDR format shown in FIG. 4A is explained. When data in the DDR-SDR format is input to this decoder together with a transmission clock (for example, in the case of 1080i, a 74.25 MHz clock), data is captured with the timing of the rising edge of the transmission clock by the flip-flop 1, and data is captured with the timing of the falling edge of the transmission clock by the inverter 3 and flip-flop 2, as shown in FIG. 10.

In DDR-SDR format data, the luminance data Y and color difference data Cb/Cr are time-division multiplexed at twice the rate of the transmission clock, so that by capturing data with the timing of the rising edge of the transmission clock the color difference data Cb/Cr is separated, and by capturing data with the timing of the falling edge of the transmission clock the luminance data Y is separated.

Here, in DDR-SDR format data since the synchronization data XY and identification codes 00, FF, 00 are added at the same rate as the transmission clock, as shown in FIG. 10, the synchronization data XY and identification codes 00, FF, 00 are captured without being separated by both the flip-flop 1 and the flip-flop 2. With respect to this fact that the synchronization data XY and identification codes 00, FF, 00 are captured without separation, the DDR-SDR format is the same as the ITU-R656 format. Hence by means of the 656 SAV/EAV detection circuit 4, the synchronization data XY can be detected based on the identification codes 00, FF, 00.

In the case where data in the DDR-SDR format is input to this decoder, under the control of the higher-level controller, the fixed value “0” is selected by the selector 14 in the YC separation circuit 5, the output of the delay circuit 6 is selected by the selector 8, and the output of the 656 SAV/EAV detection circuit 4 is selected by the selector 9.

Hence, in this case the color difference data Cb/Cr separated by the flip-flop 1 except for the blanking interval passes through the YC separation circuit 5 and is output from the decoder, and the luminance data Y separated by the flip-flop 2 except for the blanking interval passes through the delay circuit 6 and selector 8 and is output from the decoder.

[Decoding of Data in the ITU-R656 Format]

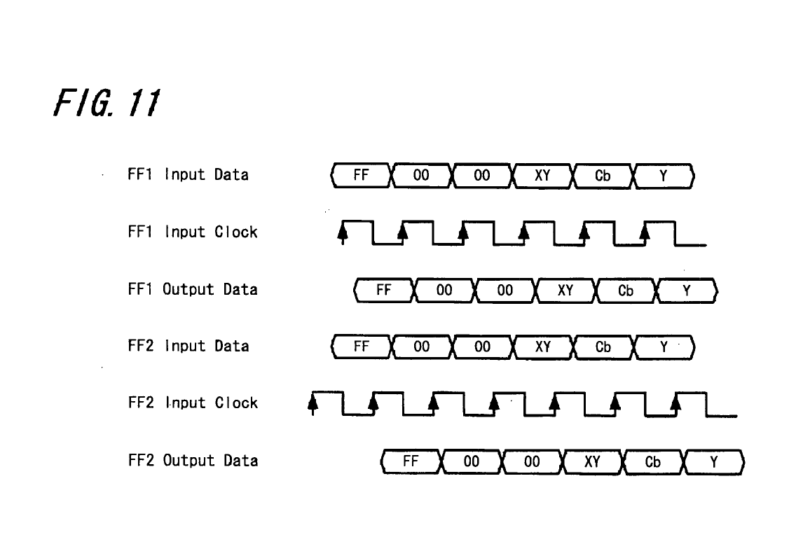

Finally, the manner of decoding data in the ITU-R656 format (FIG. 1) is explained. When data in the ITU-R656 format is input to this decoder together with a transmission clock, as shown in FIG. 11, data is captured with the timing of the rising edge of the transmission clock by the flip-flop 1, and data is captured with the timing of the falling edge of the transmission clock by the inverter 3 and flip-flop 2.

In ITU-R656 format data, the luminance data Y and color difference data Cb/Cr are time-division multiplexed at the same rate as the transmission clock, so that even if data is captured with timing at the rising edge and at the falling edge of the transmission clock, the luminance data Y and color difference data Cb/Cr are not separated.

In this case, under the control of the higher-level controller, the H timing information is selected by the selector 14 in the YC separation circuit 5, the output of the YC separation circuit 5 is selected by the selector 8, and the output of the 656 SAV/EAV detection circuit 4 is selected by the selector 9.

Hence in this case, the luminance data Y and color difference data Cb/Cr are separated by the YC separation circuit 5, except for the blanking interval, and the color difference data Cb/Cr is output from the decoder, while the luminance data Y passes through the selector 8 and is output from the decoder.

Hence as described above, regardless of whether data in the DDR-DDR format, data in the DDR-SDR format, or data in the ITU-R656 format is input, this decoder can perform decoding into the ITU-R601 format (with luminance data Y and color difference data Cb/Cr separated, and with SAV and EAV detected).

In the above embodiments, a configuration is adopted in which any among data in the DDR-DDR format, data in the DDR-SDR format, and data in the ITU-R656 format can be decoded. However, as another example, a configuration may be employed in which only data in the DDR-DDR format and data in the DDR-SDR format can be decoded. In that case, the selector 8 in FIG. 5 and the Y separation portion 12 and selector 14 in the YC separation circuit 5 of FIG. 6 may be omitted (data input to the C separation portion 13 is output without modification, other than the case in which the blanking information does not indicate an image interval).

Alternatively, a configuration may be employed in which only data in the DDR-DDR format can be decoded. In this case, the 656 SAV/EAV detection circuit 4, selector 8, and selector 9 in FIG. 5, and the Y separation portion 12 and selector 14 in the YC separation circuit 5 in FIG. 6 may be omitted (data input to the C separation portion 13 is output without modification, other than the case in which the blanking information does not indicate an image interval).

Further, in the above embodiments, the timing information/synchronization signal generation circuit 10 generates a horizontal synchronization signal Hsync and vertical synchronization signal Vsync from the synchronization data XY of the SAV and EAV codes detected by the 656 SAV/EAV detection circuit 4 and by the DDR-DDR SAV/EAV detection circuit 7. However, in the case where a horizontal synchronization signal and vertical synchronization signal supplied from outside are used without modification, a configuration may be employed in which the horizontal synchronization signal and vertical synchronization signal are not generated from the synchronization data XY (and the SAV and EAV codes are used only for generation of timing information and blanking information).

In the above embodiments, this invention is applied in order to decode into the ITU-R601 format such data in the DDR-DDR format and DDR-SDR format shown in FIGS. 4A and 4B, which, while based on the ITU-R656 format, have the luminance data, color difference data, synchronization data, and identification codes at twice the rate of the transmission clock, or the luminance data and color difference data at twice the rate of the transmission clock and the synchronization data and identification codes at the same rate as the transmission clock.

However, this invention may also be applied to other types of data as well, in formats with the luminance data, color difference data, synchronization data, and identification codes at twice the rate of the transmission clock, or with the luminance data and color difference data at twice the rate of the transmission clock and the synchronization data and identification codes at the same rate as the transmission clock, to separate the luminance data and the above color difference data.

It should be understood by those skilled in the art that various modifications, combinations, sub-combinations and alternations may occur depending on design requirements and other factors insofar as they are within the scope of the appended claims or the equivalents thereof.

What is claimed is:

1. An image decoder, which separates luminance data and color difference data from image data in a format in which said luminance data and said color difference data are time-division multiplexed, with synchronization data indicating the beginning and end of the image interval as well as identification codes for identification of said synchronization data added at several times the rate of a transmission clock, comprising:
first capture means for capturing said image data with timing at the rising edge of the transmission clock input together with said image data;
second capture means for capturing said image data with timing at the falling edge of said transmission clock; and
detection means for rendering uniform the timing of the output data of said first capture means and of the output data of said second capture means, for judging the presence of said identification codes from the signals with timing rendered uniform, and for detecting said synchronization data with the timing of the presence of said identification codes.

2. The image decoder according to claim 1,
wherein with respect to said image data, three of said identification codes are added to one of said synchronization data, and
said detection means renders uniform the timing of the current output data from said first capture means, the output data one clock cycle previous of said first capture means, the current output data of said second capture means and the output data one clock cycle previous of said second capture means, and of the four data items with timing rendered uniform, detects one data item as said synchronization data with the timing of the other three data items being said identification codes.

3. The image decoder according to claim 1,
wherein said image data is image data in a format which, while based on ITU-R656, is a format in which said luminance data, said color difference data, said synchronization data, and said identification codes are at twice the rate of the transmission clock.

4. The image decoder according to claim 1, further comprising:
second detection means for detecting said synchronization data from only the output data of one among said first capture means and said second capture means,
wherein, in the case where second image data is input in a format in which luminance data and color difference data are time-division multiplexed, synchronization data indicating the beginning and end of an image interval and identification codes for identification of said synchronization data are added, with said luminance data and said color difference data at twice the rate of the transmission clock and said synchronization data and said identification codes at the same rate as the transmission clock, said identification data is detected by said second detection means.

5. The image decoder according to claim 4,
wherein said second image data is image data in a format in which, while based on ITU-R656, said luminance data and said color difference data are at twice the rate of the transmission clock, and said synchronization data and said identification codes are at the same rate as the transmission clock.

6. An image decoding method, for separating luminance data and color difference data from image data in a format in which said luminance data and said color difference data are time-division multiplexed, and synchronization data indicating the beginning and end of an image interval and identification codes to identify said synchronization data are added at several times the rate of a transmission clock, comprising:
a first capture step of capturing said image data with the timing of the rising edge of the transmission clock input together with said image data;
a second capture step of capturing said image data with the timing of the falling edge of said transmission clock input together with said image data; and
a detection step of rendering uniform the timing of the signal captured in said first capture step and the signal captured in said second capture step, of judging whether said identification codes exist from the signals with timing rendered uniform, and of detecting said synchronization data with the timing of the presence of said identification codes.

7. The image decoding method according to claim 6,
wherein with respect to said image data, three of said identification codes are added to one of said synchronization data, and
in said detection step, the timing of the current output data from said first capture means, the output data one clock cycle previous of said first capture means, the current output data of said second capture means, and the output data one clock cycle previous of said second capture means is rendered uniform, and of the four data items with timing rendered uniform, one data item is detected as said synchronization data, with the timing of the other three data items being said identification codes.

8. The image decoding method according to claim 6,
wherein said image data is image data in a format which, while based on ITU-R656, is a format in which said luminance data, said color difference data, said synchronization data, and said identification codes are at twice the rate of the transmission clock.

9. The image decoding method according to claim 6, further comprising:
a second detection step of detecting said synchronization data from only the signal captured in one among said first capture step and said second capture step,
wherein, in the case where second image data is input in a format in which luminance data and color difference data are time-division multiplexed, and synchronization data indicating the beginning and end of an image interval and identification codes for identification of said synchronization data are added, with said luminance data and said color difference data at twice the rate of the transmission clock and said synchronization data and said identification codes at the same rate as the transmission clock, said identification data is detected in said second detection step.

10. The image decoding method according to claim 9,
wherein said second image data is image data in a format in which, while based on ITU-R656, said luminance data and said color difference are at twice the rate of the transmission clock, and said synchronization data and said identification codes are at the same rate as the transmission clock.

11. An image decoder, which separates luminance data and color difference data from image data in a format in which said luminance data and said color difference data are time-division multiplexed, with synchronization data indicating the beginning and end of the image interval as well as identification codes for identification of said synchronization data added at several times the rate of a transmission clock, comprising:
a first capture unit for capturing said image data with timing at the rising edge of the transmission clock input together with said image data;
a second capture unit for capturing said image data with timing at the falling edge of said transmission clock; and
a detector for rendering uniform the timing of the output data of said first capture unit and of the output data of said second capture unit, for judging the presence of said identification codes from the signals with timing rendered uniform, and for detecting said synchronization data with the timing of the presence of said identification codes.
